(19) United States
(12) Patent Application Publication
(10) Pub. No.: US 2016/0296901 A1
(43) Pub. Date: Oct. 13, 2016

(54) METHOD FOR APPLYING A VISCOUS MATERIAL

(71) Applicant: SCA SCHUCKER GMBH & CO. KG, Bretten (DE)

(72) Inventors: Nils KOHLHASE, Leonberg (DE); Olaf LEONHARDT, Koenigsbach (DE)

(73) Assignee: SCA Schucker GmbH & Co. KG, Bretten (DE)

(21) Appl. No.: 15/101,226

(22) PCT Filed: Dec. 10, 2014
(86) PCT No.: PCT/EP2014/077133

§ 371 Date: Jun. 2, 2016

(30) Foreign Application Priority Data
Dec. 16, 2013 (DE) 10 2013 020 629.4

(51) Int. Cl. B01F 15/04; B01F 15/00; B32B 37/12; B05B 12/14; B05C 11/10

(52) U.S. Cl. CPC B01F 15/0404; B05B 12/1418; B05C 11/1036; B32B 37/1284; B01F 15/00175; B32B 2037/1253

(57) ABSTRACT

A method applies an at least two-component, curable and viscous material in the form of a material strand or a series of material points to a workpiece, an application process starting at an application start time and ending at an application end time, and the workpiece with the material applied thereon being destined for further processing which starts at a processing start time and ends at a processing end time. The mixing ratio of the components is varied by a control device depending on predetermined and/or measured parameters during the application process in such a way that the material applied to the workpiece can be processed at any point of the material strand or at any material point at the processing starting time.

The invention relates to a method for application of an at least two-component, curable and viscous compound in the form of a compound strand or a series of compound spots onto a wprkpiece, wherein en application process begins at an application starting time and ends at an application ending time, and wherein the workpiece with the applied compound is intended for a further processing process, which begins at a further processing starting time and ends at a further processing ending time.

In known methods of this type, a two-component or multi-component adhesive, for example, is applied onto an automobile body part and the body part is joined to another body part either after the application process or some time later, wherein the other body part is pressed onto the compound strand or the series of compound, spots and then the compound is cured. For larger workpieces, on which a longer compound strand is applied and for which the application process therefore lasts considerable time, the problem often exists that the beginning of the compound strand applied at the application starting time cures considerable time before the end of the compound strand applied at the application ending time. This may lead to the situation that the end of the compound strand is indeed still further-processable without difficulty at the further processing starting time, but the beginning of the compound strand is already cured and can no longer be further processed, for example joined to another body part. The same is true for a series of compound spots, of which the compound spots first applied may already be cured at the further processing starting time.

From DE 10 2005 02 6 050 A1 a method for application of beads of a pasty compound is known in which the quantitative feed of the components of the pasty compound into a mixing chamber is time-controlled, in order to produce a slowly curing mixture at the end of the application of a bead. Thus longer interruptions of the application process are possible without the need to flush the mixing chamber. From DE 10 2 008 000 12 6A1 an application method is known in which the pot life of a mixture applied by rotary casting on a roll to be coated is adjusted to a. desired value.

It is therefore the task of the invention to improve a method of the type mentioned in the introduction to the effect that further processing of the compound strand or of the series of compound spots is facilitated.

This task is accomplished according to the invention by the fact that the mixing ratio of the components is varied by a control device as a function of predetermined arid/or measured parameters during the application process in such a way that, at the further processing starting time and preferably also at the further processing ending time, the compound applied an the workplace is advantageously further processable to the same extent at each place of the compound strand or at each compound spot. In particular, it is intended that the pot life of the compound at each place of the compound strand or at each compound spot is not yet exceeded at the further processing starting time, which is already known and expediently can be predetermined before the application process, and preferably also at the further processing ending time.

In most application cases, the components have a base component and a base curing agent. Thus it is possible to vary the mixing ratio of the, base component and of the base curing agent during the application process, by increasing the concentration of the base curing agent relative to the concentration of the base component. The beginning of the compound strand, which is first applied, or the compound spots that are first applied then cure after a longer time interval than the end of the compound strand applied at a later time or the last applied compound spots. This embodiment has the advantage that only two components are needed.

However, it is also possible to apply the base component and the base curing agent in constant mixing ratio and to admix at least one additional component in variable concentration. The additional component or one of the additional components may be an additional curing agent that accelerates the curing of the compound and the concentration of which increases in the course of the application process. However, it is also possible for the additional component or one of the additional components to be a retarding agent that retards the curing of the compound and the concentration of which, decreases in the course of the application process. Both variants have the end result that the beginning of the compound strand, which is first applied, or the first applied compound spots need longer for curing than the end of the compound strand, which is last applied, or the last applied compound spots.

According to an advantageous exemplary embodiment, the mixing ratio of the components is varied as a function of the predetermined and/or measured parameters in such a way that the compound applied on the workpiece begins to cure at approximately or if possible at exactly the same time after the further processing ending time at every place of the compound strand or at every compound spot. It is also possible to specify a time window, within which the compound cures at its individual places. For example, the time at which the curing begins may lie shortly after the joining, completed at the further processing ending time, of the workpiece provided with the compound to another workpiece.

The predetermined parameters on which the change in time of the mixing ratio depends can be, for example, the application duration, and therefore the interval between the application starting time and the application ending time, or the time interval between the application starting time or the application ending time and the further processing starting time or the further processing ending time. In addition, predetermined parameters may be the specific properties of the individual components. In particular, the temperature of the environment, the temperature of the work/piece, the temperature of the components and the temperature ox the compound, which can be measured by means of a temperature sensor, can be considered as measured parameters.

The invention will be explained in more detail in the following on the basis of an exemplary embodiment illustrated in schematic: manner in the drawing, wherein:

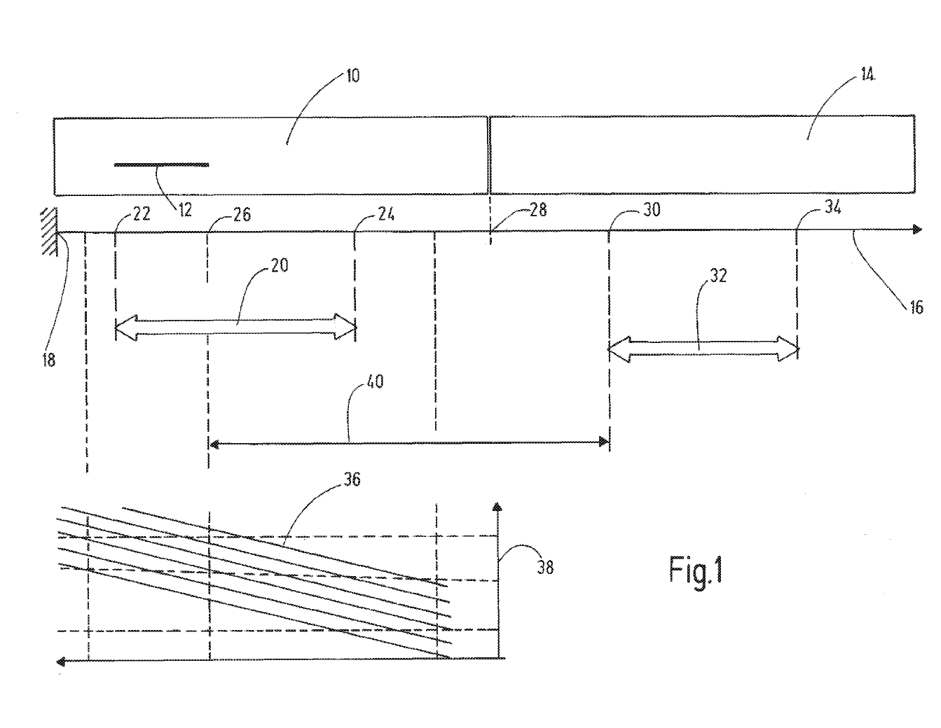

FIG. 1 shows a schematic illustration of an adhesive application method in the form of a diagram.

In the drawing it is schematically illustrated in the form of a diagram how a two-component adhesive consisting of a base component and a base curing agent are applied in an application station 10 in the form of an adhesive strand 12 onto a workpiece, which will be joined to another workplace in a joining station 14 at a later time. The sequence of working steps is schematically illustrated via a time axis 16, the origin 18 of which coincides with the time at which the workpiece is introduced into the application station 10. The adhesive application process 20 begins at an application starting time 22 and ends at an application ending time 24. In the drawing, the adhesive strand 12 is schematically illustrated at an application time 26 lying between the application starting time 22 and the application ending time 24. At a transfer time 28, the workpiece is transferred from the application station 10 to the joining station 14. At a further processing starting time 30 after the transfer time 28, a further processing process 32 begins, in which the workplace provided with the adhesive strand 12 is joined to another workplace, and which ends at a further processing ending time 34.

In order to guarantee a flawless joining process, the adhesive strand 12 must be further processable at the further processinq starting time 30 and. preferably also at the further processing ending time 34. This means that it is not permissible for the pot life of the adhesive strand 12 to have expired at any place at the said times. Furthermore, it is necessary that the adhesive strand 12 begins to cure over its entire length at approximately the same time later than the further processing ending time 34. In order to achieve this, the mixing ratio between base component and base curing agent is varied in time during the application process 20, for which purpose the proportion of the base component decreases in the course of time.

Since the duration of the application process 20, the duration of the further processing process 32 and the interval between the application ending time 24 and the further processing starting time 30 may vary, a family of curves 36, corresponding to the mixing ratio defined by the proportion of the base component, is plotted in a control device controlling the application process 22 over the time interval, between the respective application time 26 and the further processing starting time 30, wherein each of the curves reproduces the mixing ratio predetermined by the control device for a particular adhesive temperature. The family of curves 36 is determined by a calibration process for different adhesive temperatures. In the illustrated exemplary embodiment, the mixing ratio 38 is plotted over the time interval 40 between the respective application time 26 and the further processing starting time 30. If the required criterion is that the adhesive strand 12 must also be further processable at each place at the further processing ending time 34, the mixing ratio 38 will be expediently plotted over the time interval between the respective application time 26 and the further processing ending time 34, The temperature of the adhesive strand 12 will be measured during application onto the workpiece by means of a temperature sensor and communicated to the control device, so that this can select the correct curve from the family of curves 36.

The mixing ratio 38 is therefore varied in time as a function of predetermined parameters, such as the application starting time 22, the application ending time 24, the further processing starting time 30 and the further processing ending time 34, and also as a function of measured parameters, such as the temperature of the adhesive strand 12, in such a way that the adhesive strand 12 is still further processable to equal extents over its entire length at the further processing starting time 30 and the further processing ending time 34 respectively.

It is self-evident that the illustrated exemplary embodiment is to be considered merely as an example, In particular, a time window can be specified between the removal of the workpiece from the application station 10 and the insertion of the workpiece into the joining station 14. It is also possible for the application ending time 24 to coincide with the further processing starting time 30, which in turn may coincide with the further processing ending time 34. This is then the case, for example, when the adhesive strand 12 bonding the workplaces with one another is introduced between two workpieces already positioned relative to one another. If the further processing starting time 30 lies at a later time, for example, the time interval 40 relative to each application time 26 is prolonged compared with the illustrated exemplary embodiment, and respectively less base curing agent has to be admixed relative to the base component. In this way the further processing process 32 is freely selectable within limits.

In summary, the following may be stated; The invention relates to a method for application of an at least two-component, curable and viscous compound in the form of a compound strand 12 or a series of compound spots onto a workpiece, wherein an application process 20 begins at an application starting time 22 and ends at an application ending time 24, and wherein the workpiece with the applied compound is intended for a further processing operation 32, which begins at a further processing starting time 30 and ends at a further processing ending time 34. According to the invention, it is provided that the mixing ratio 38 of the components is varied by a control device as a function of predetermined and/or measured parameters 22, 24, 30, 34 during the application process 20 in such a way that, at the further processing starting time 30, the compound applied on the workplace is further processable at each place of the compound strand 12 or at each compound spot.

1. Method for application of an at least two-component, curable and viscous compound in the form of a compound strand (12) or a series of compound spots onto a workpiece, wherein an application process (20) begins at an application starting time (22) and ends at an application ending time (24), and wherein the workpiece with the applied compound is intended for a further processing process (32), which begins at a further processing starting time (30) and ends at a further processing ending time (34), wherein the mixing ratio (38) of the components is varied by a control device as a function of predetermined and/or measured parameters (22, 24, 30, 34) during the application process (20) in such a way that, at the further processing starting time (30), the compound applied on the workpiece is further processable at each place of the compound strand (12) or at each compound spot.

2. Method according to claim 1, wherein, at the further processing ending time (34), the applied compound is further processable at each place of the compound strand (12) or at each compound spot.

3. Method according to claim 1, wherein the mixing ratio of the components is varied as a function of the predetermined and/or measured parameters in such a way that the compound applied on the workpiece begins to cure at approximately the same time after the further processing ending time (34) at every place of the compound strand (12) or at every compound spot.

4. Method according to claim 1, wherein the mixing ratio (38) of the components is varied as a function of the temperature of the environment and/or the temperature of the workpiece and/or the temperature of the components and/or the temperature of the compound.

5. Method according to claim 4, wherein the temperature of the environment and/or the temperature of the workpiece and/or the temperature of the components and/or the temperature of the compound is measured, preferably as a function of time, by means of at least one temperature sensor and communicated to the control device.

6. Method according to claim 4, wherein the temperature of the environment and/or the temperature of the workpiece and/or the temperature of the components and/or the temperature of the compound is saved as a predetermined and preferably estimated parameter in the control device.

7. Method according to one of the claim 1, wherein, prior to the application process (20), the necessary mixing ratios (38) of the components are determined in a calibration process as a function of the parameters and saved in the control device.

8. Method according to claim 1, wherein the components comprise a base component and a base curing agent.

9. Method according to claim 8, wherein the mixing ratio (38) of the base component and of the base curing agent is varied during the
application process (20), wherein the concentration of the base curing agent is increased relative to the concentration of the base component.

10. Method according to claim 8, wherein the base component and the base curing agent are applied in constant mixing ratio and wherein at least one additional component is admixed in variable concentration.

11. Method according to claim 10, wherein the additional component or one of the additional components is an additional curing agent that accelerates the curing of the compound and the concentration of which increases in the course of the application process (20).

12. Method according to claim 10, wherein the additional component or one of the additional components is a retarding agent that retards the curing of the compound and the concentration of which decreases in the course of the application process (20).
